(19) United States
(12) Patent Application Publication
(10) Pub. No.: US 2025/0314850 A1
(43) Pub. Date: Oct. 9, 2025

(54) LENS UNIT

(71) Applicant: Ryoichi TERANISHI, Tokyo (JP)

(72) Inventor: Ryoichi TERANISHI, Kanagawa (JP)

(21) Appl. No.: 18/862,967

(22) PCT Filed: May 10, 2023
(86) PCT No.: PCT/IB2023/054816

§ 371 Date: Nov. 5, 2024

(30) Foreign Application Priority Data
May 17, 2022 (JP) 2022-080957

(51) Int. Cl. G02B 7/02

(52) U.S. Cl. CPC G02B 7/026; G02B 7/021

(57) ABSTRACT

A lens unit includes: multiple lenses arranged along an optical axis of the lens unit, the multiple lenses including at least one resin lens; a lens barrel housing the multiple lenses, the lens barrel including a fit-receiving portion; and a pressure member configured to press the multiple lenses housed in the lens barrel. Said at least one resin lens including a fit-in portion fittable into the fit-receiving portion. Each of the fit-in portion and the fit-receiving portion has: a tapered cross-sectional shape in the optical axis; and a shape of a circle centered on the optical axis in a plane orthogonal to the optical axis. A diameter of the circle differs with a position in the optical axis.

### TECHNICAL FIELD The present disclosure relates to a lens unit.

### BACKGROUND ART

A lens unit includes multiple lenses including at least one resin lens arranged along the optical axis, a lens barrel housing the multiple lenses, and a pressing member pressing the multiple lenses housed in the lens barrel. Such a lens unit has applications in cameras mounted on mobile objects, such as automobiles and drones, and monitoring cameras located in buildings. To reduce or prevent a change in the performance of the lens unit due to the deformation of a resin lens, a configuration is proposed that the resin lens is composed of a lens portion serving as a lens and a flange portion at the outside of the lens portion, which allows stress to be concentrated on the flange portion (for example, patent literature (PTL) 1).

However, the configuration of PTL 1 might cause a change in the performance of the lens unit due to a change in its state from that at the time of assembly.

### CITATION LIST

### Patent Literature

### PTL 1

Japanese Unexamined Patent Application Publication No. 2020-046562

### SUMMARY OF INVENTION

### Technical Problem

Embodiments of the present disclosure aim to provide a lens unit that reduces or prevents a change in its state from that at the time of assembly.

### Solution to Problem

A lens unit includes: multiple lenses arranged along an optical axis of the lens unit, the multiple lenses including at least one resin lens; a lens barrel housing the multiple lenses, the lens barrel including a fit-receiving portion; and a pressure member configured to press the multiple lenses housed in the lens barrel. Said at least one resin lens including a fit-in portion fittable into the fit-receiving portion. Each of the fit-in portion and the fit-receiving portion has: a tapered cross-sectional shape in the optical axis; and a shape of a circle centered on the optical axis in a plane orthogonal to the optical axis. A diameter of the circle differs with a position in the optical axis.

A lens unit includes: multiple lenses arranged along an optical axis of the lens unit, the multiple lenses including at least two resin lenses; a lens barrel housing the multiple lenses; and a pressure member configured to press the multiple lenses housed in the lens barrel. Said at least two resin lenses includes: a first resin lens; and a second resin lens adjacent to the first resin lens. The first resin lens includes a fit-receiving portion. The second resin lens includes a fit-in portion fittable into the fit-in portion. Each of the fit-in portion and the fit-receiving portion has: a tapered cross-sectional shape in the optical axis; and a shape of a circle centered on the optical axis in a plane orthogonal to the optical axis. A diameter of the circle differs with a position in the optical axis.

### Advantageous Effects of Invention

Embodiments of the present disclosure enable a lens unit that reduces or prevents a change in its state from that at the time of assembly.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a vertical cross-sectional view of a lens unit according to a first embodiment.

FIG. 2 is a plan view of a resin lens included in the lens unit in FIG. 1.

FIG. 3 is a vertical cross-sectional view of a lens unit according to a comparative example.

FIG. 4 is a vertical cross-sectional view of a lens unit according to the second embodiment.

FIG. 5 is a plan view of a second resin lens included in the lens unit of FIG. 4.

FIG. 6 is a vertical cross-sectional view of a lens unit according to the third embodiment.

FIG. 7 is a plan view of a resin lens included in the lens unit of FIG. 6.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring to the drawings, a lens unit is described in detail according to embodiments of the present disclosure.

A lens unit 1000 according to embodiments of the present disclosure are described below to implement the technical ideas, and no limitation is indicated to the embodiments of the present disclosure given below. For example, the size, material, and shape of components and the relative positions of the arranged components are given by example in the following description. The scope of the present disclosure is not limited thereto unless particularly specified. For example, the size of these elements and the relative positions of these elements may be exaggerated for illustration in the drawings. In the description given below with reference to the drawings, like reference signs denote like elements, and overlapping description may be simplified or omitted as appropriate.

### First Embodiment

### Example Configuration of Lens Unit 100

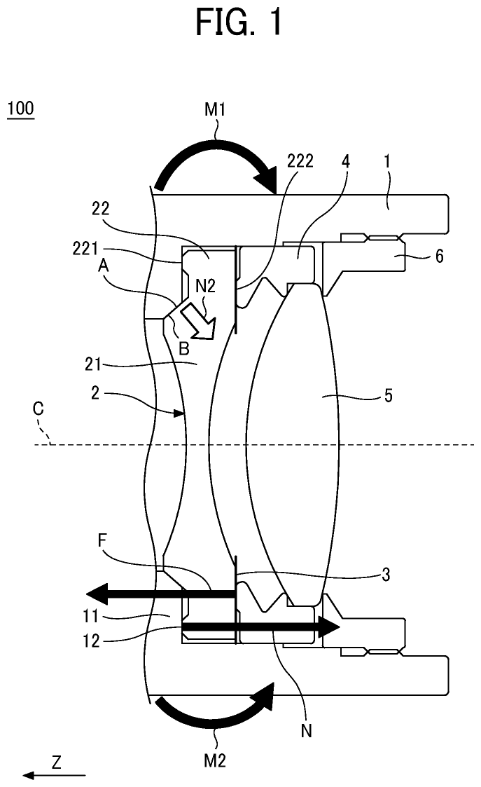

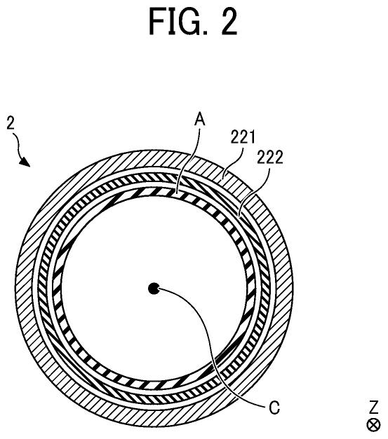

The configuration of the lens unit 100 according to the first embodiment will be described with reference to FIGS. 1 and 2. FIG. 1 is a vertical cross-sectional view of the configuration of the lens unit 100. FIG. 2 is a plan view of the resin lens 2 in the lens unit 100 of FIG. 1 in a direction orthogonal to the negative direction along the Z-axis (hereinafter referred to as −Z-direction). The direction indicated by arrow Z in FIG. 2 refers to the positive direction along the Z-axis (hereinafter referred to as +Z-direction). The −Z-direction is a direction opposite to the +Z-direction.

As illustrated in FIG. 1, the lens unit 100 includes a lens barrel 1, a resin lens 2, a light shield 3, a spacer ring 4, a glass lens 5, and a pressing member 6.

The lens barrel 1 includes a fit-receiving portion B and houses the resin lens 2 and the glass lens 5. The material of the lens barrel 1 is metal such as aluminum. However, the material of the lens barrel 1 may be resin.

In the present embodiment, the lens barrel 1 is formed in a hollow and substantially cylindrical shape. The lens barrel 1 includes the resin lens 2, the light shield 3, the spacer ring 4, and the glass lens 5 internally housed in that order. The lens barrel 1 includes a small-diameter portion 11 and a contact surface 12.

The small-diameter portion 11 is ring-shaped provided in a part of the inner side of the lens barrel 1. The inner diameter of the small-diameter portion 11 is smaller than the outer diameter of the resin lens 2 housed in the lens barrel 1. The small-diameter portion 11 includes a fit-receiving portion B.

The fit-receiving portion B includes a tapered shape in which a diameter with the optical axis C as its center varies depending on a position in a direction along the optical axis C. In other words, the fit-receiving portion B includes a tapered cross-sectional shape in the optical axis C; a shape of a circle centered on the optical axis C in a plane orthogonal to the optical axis; and a diameter of the circle differs with a position in the optical axis. In the present embodiment, the fit-receiving portion B includes a substantially conical tapered shape in which the diameter of a circle centered on the optical axis C increases in a direction to the image formed by the lens unit 100 (i.e., in the −Z-direction).

The contact surface 12 included in the small-diameter portion 11 is a surface substantially orthogonal to the optical axis C of the lens unit 100. The resin lens 2 housed in the lens barrel 1 is brought into contact with the contact surface 12.

The resin lens 2 and the glass lens 5 correspond to multiple lenses arranged along the optical axis C.

In the present embodiment, the resin lens 2 is made of resin. The glass lens 5 is made of glass. However, the lens unit 100 may include a resin lens different from the resin lens 2 instead of the glass lens 5.

At least a part of the outer periphery of the resin lens 2 is formed in a substantially circular columnar shape. The outer diameter of the substantially circular columnar shape of the resin lens 2 is smaller than the inner diameter of the lens barrel 1. Thus, the resin lens 2 is housed in the lens barrel 1 with a gap (air layer) between the resin lens 2 and the lens barrel 1.

The resin lens 2 includes a lens portion 21 and a flange portion 22. The lens portion 21 has the optical axis C at its center and acts as a lens for the light incident on the resin lens 2.

The flange portion 22 is outside the lens portion 21. The flange portion 22 does not act as a lens for the light incident on the resin lens 2. The flange portion 22 includes a fitting portion A, a first portion 221, and a second portion 222.

The fit-in portion A can be fitted to the fit-receiving portion B. The diameter of the tapered shape in the fit-in portion A is slightly smaller than the diameter of the tapered shape in the fit-receiving portion B as a whole. The fit-in portion A is formed at a surface of the flange portion 22, which is closer to the object (than the other surfaces of the flange portion) in a direction toward the object (i.e., in the +Z-direction). The fit-in portion A includes a tapered shape in which a diameter with the optical axis C as its center varies depending on a position in the direction along the optical axis C. In other words, the fit-in portion A has a tapered cross-sectional shape in the optical axis C; a shape of a circle centered on the optical axis C in a plane orthogonal to the optical axis; and a diameter of the circle differs with a position in the optical axis. In the present embodiment, the fit-in portion A includes a substantially conical tapered shape in which the diameter of a circle centered on the optical axis C increases in the −Z-direction.

The first portion 221 is a ring-shaped portion contacting the lens barrel 1. The lens barrel 1 is an example of a first member. The first portion 221 is a side surface of the flange portion 22, with the side surface facing in the +Z-direction and being substantially orthogonal to the optical axis C. The first portion 221 comes into contact with an annular region of a face of the small-diameter portion 11 of the lens barrel 1, the face being substantially orthogonal to the optical axis C.

The second portion 222 is a ring-shaped portion that comes into contact with the spacer ring 4 at the opposite side of the flange portion 22 across the first portion 221 along the optical axis C. The spacer ring 4 is an example of a second member. The second portion 222 is another side surface of the flange portion 22, said another side surface facing in the −Z-direction and being substantially orthogonal to the optical axis C. The spacer ring 4 has a face substantially orthogonal to the optical axis C, which comes into contact with the ring-shaped region of the second portion 222 with the light shield 3 between the face of the spacer ring 4 and the second portion 222.

As illustrated in FIG. 2, in the resin lens 2 the second portion 222 is between the fit-in position A and the first portion 221 in a direction orthogonal to the optical axis C. In other words, the relative position between the fit-in portion A, the first portion 221, and the second portion 222 are such that the fit-in portion A, the second portion 222, and the first portion 221 are arranged in order of distance from the optical axis C.

As illustrated in FIG. 1, the light shield 3 blocks disturbance light and unintended reflected light striking on the lens unit 100. For example, the light shield 3 is a sheet member with a thickness of about several tens of um. The material of the light shield 3 is not limited to any particular material, but may use a resin or a metal. Note that the light shield 3 may not be used.

The spacer ring 4 restricts a predetermined spacing (distance) between the resin lens 2 and the glass lens 5.

The spacer ring 4 is formed in a substantially circular columnar shape and is housed in the lens barrel 1 with the glass lens 5 supported internally by the spacer ring 4. The outer diameter of the spacer ring 4 is slightly smaller than the inner diameter of the lens barrel 1. This allows the spacer ring 4 to be fitted to the lens barrel 1. The material of the spacer ring 4 is not limited to any particular material but may use a resin or a metal.

The pressing member 6 presses the resin lens 2 and the glass lens 5 housed in the lens barrel 1. The pressing member 6 has a first screw portion at a part of an outer portion of the pressing member 6. The pressing member 6 presses the spacer ring 4 supporting the resin lens 2, the light shield 3, and the glass lens 5 by coupling the first screw portion of the pressing member 6 with a second screw portion on the inner side of the lens barrel 1 and an end portion of the lens barrel 1 in the −Z-direction. The pressing member 6 pressing the spacer ring 4 allows these elements (i.e., the resin lens 2, the light shield 3, and the glass lens 5) to be secured to the lens barrel 1. The material of the pressing member 6 is not limited to any particular material but may use a resin or a metal.

### Operation of Lens Unit 100

The following describes the operations of the lens unit and a method of assembling the lens unit 100.

When assembling the lens unit 100, the resin lens 2 is first inserted into the lens barrel 1. The first portion 221 of the resin lens 2 comes into contact with the contact surface 12 of the small-diameter portion 11 of the lens barrel 1.

Before the pressing force is applied by the pressing member 6, there is a slight gap between the fit-in portion A of the resin lens 2 and the fit-receiving portion B of the lens barrel 1. With such a gap therebetween, the resin lens 2 is positioned in the radial direction.

Subsequently, the spacer ring 4 is inserted into the interior of the lens barrel 1. The spacer ring 4 has a face substantially orthogonal to the optical axis C that comes into contact with the second portion 222 of the resin lens 2 with the light shield 3 between the face of the spacer ring 4 and the second portion 222. The spacer ring 4 then supports the glass lens 5 inside the spacer ring 4.

Subsequently, a pressing force is applied to the resin lens 2 in the direction along the optical axis C by coupling the first screw portion of the pressing member 6 to the second screw portion of the lens barrel 1. The pressing force is applied to the resin lens 2 after being transmitted through the elements housed in the lens barrel 1. In the resin lens 2, the pressing force F is applied from the spacer ring 4 to the second portion 222. As a reaction of the pressing force F, a drag force N is generated in the first portion 221 of the resin lens 2 in a direction opposite the pressing force F.

The second portion 222 is closer to the optical axis C than the first portion 221. In this relative position between the first portion 221 and the second portion 222, moment M1 and moment M2 is applied to the resin lens 2. Due to the moment M1 and the moment M2, the resin lens 2 is deformed, so the central portion of the resin lens 2 protrudes in the +Z-direction.

The deformation of the resin lens 2 fills the gap between the fit-in portion A and the fit-receiving portion B, causing the fit-in portion A and the fit-receiving portion B to come into contact with each other. The fit-in portion A contacting the fit-receiving portion B causes a drag force N2 from the fit-in portion A to act on the resin lens 2, thus allowing the drag force N to balance with the moment M1 and the moment M2. Such a well balance between the drag force N and the moments M1 and M2 reduces the deformation of the resin lens 2 due to the ambient temperature around the lens unit 100 and the passage of time.

As the tapering angle of each of the fit-in portion A and the fit-receiving portion B increases (i.e., as the tilt angle of each surface of the fit-in portion A and the fit-receiving portion B relative to the optical axis C increases), the direction in which the drag force N2 is applied (the direction of the drag force N2) becomes closer to parallel to the optical axis C. In this configuration, since a small drag force N2 can be well balanced with the moments M1 and M2, each surface of the fit-in portion A and the fit-receiving portion B preferably has a large tapering angle relative to the optical axis C.

### Comparative Example

A comparative example of the lens unit is described below.

In recent years, lens units including resin lenses have been increasingly used in in-vehicle applications where performance must be guaranteed over a wide temperature range. As such a lens unit, there is known a lens unit in which a lens is supported from its both sides and secured to a lens barrel.

The resin lens changes its shape significantly with temperature changes or over time. For this reason, the pressing force applied to the resin lens is preferably set as high as possible at the time of assembly, i.e., at the time of manufacturing the lens unit, so as to prevent lack of the pressing force during use of the lens unit. However, since the resin lens is softer than the glass lens, the amount of deformation increases when the pressing force is large. The deformation of the lens changes the performance of the lens unit. Given such circumstances, there is a demand for a lens unit that prevents or reduces a change in performance due to deformation of a resin lens while maintaining a pressing force applied to the resin lens during use of the lens unit.

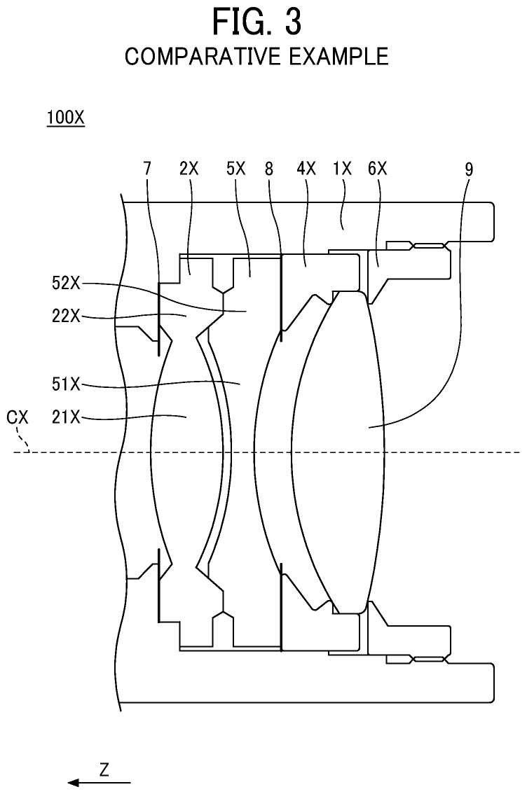

FIG. 3 is a vertical cross-sectional view of a configuration of a lens unit 100X according to a comparative example. The lens unit 100X includes a first light shield 7, a resin lens 2X, a first lens 5X, a second light shield 8, a spacer ring 4X, a second lens 9, and a pressing member 6X. These elements are arranged in this order along the optical axis CX and housed in the lens barrel 1X.

The resin lens 2X and the first lens 5X are made of resin. The second lens 9 is made of glass. At least a part of the outer periphery of each resin lens 2X and the first lens 5X is formed in a substantially circular columnar shape. The outer diameters of the substantially circular columnar shape of the resin lens 2X and the first lens 5X are smaller than the inner diameter of the lens barrel 1X. Thus, the resin lens 2X and the first lens 5X are housed in the lens barrel 1 with a gap (air layer) between the resin lens 2X and the first lens 5X and the lens barrel 1X.

The resin lens 2X includes a first lens portion 21X and a first flange portion 22X. The first lens portion 21X is located at the center portion of the resin lens 2X and acts as a lens for light incident on the resin lens 2X. The first flange portion 22X is located outside the first lens portion 21X. The first flange portion 22X has a first surface on the +Z-side (i.e., +Z-side surface) that presses the lens barrel 1X in a direction along the optical axis CX. The first flange portion 22X has a second surface on the −Z-side (i.e., −Z-side surface) that presses the first lens 5X in the direction along the optical axis CX.

The first lens 5X includes a second lens portion 51X and a second flange portion 52X. The second lens portion 51X is located at the center portion of the first lens 5X and acts as a lens for light incident on the first lens 5X. The second flange portion 52X is located outside the second lens portion 51X. The second flange portion 52X has a first surface on the +Z-side (i.e., +Z-side surface) that presses the resin lens 2X in the direction along the optical axis CX. The second flange portion 52X has a second surface on the −Z-side (i.e., −Z-side surface) that presses the spacer ring 4X in the direction along the optical axis CX.

The spacer ring 4X is formed in a substantially-circular tubular shape and internally supports the second lens 9. The spacer ring 4 restricts a predetermined spacing (distance) between the first lens 5X and the second lens 9. The outer diameter of the spacer ring 4 is slightly smaller than the inner diameter of the lens barrel 1X. This allows the spacer ring 4X to be fitted into the lens barrel 1X with a slight gap between the spacer ring 4X and the lens barrel 1X.

The first light shield 7 and the second light shield 8 each block disturbance light incident on the lens unit 100X and unintended light reflected inside the lens unit 100X.

The pressing member 6X has a first screw portion at a part of an outer portion of the pressing member 6X. The pressing member 6X presses each element housed in the lens barrel 1X by coupling the first screw portion with a second screw portion at an inner portion of the lens barrel 1X.

In assembling the lens unit 100X, the first light shield 7 first is inserted into the lens barrel 1X before the resin lens 2X is inserted into the lens barrel 1X to come into contact with the lens barrel 1X with the first light shield 7 between the lens barrel 1X and the resin lens 2X. Thus, the resin lens 2X is positioned in the direction along the optical axis CX. The spacer ring 4X supporting the second lens 9 and the second light shield 8 are also sequentially inserted into the lens barrel 1X.

Positioning each element in the radial direction is achieved by fitting each element with d by fitting each member with any one of the lens barrel 1X, the first lens 5X, and the spacer ring 4X. The resin lens 2X is fitted into the first lens 5X so as to be positioned, and the second lens 9 is fitted into the spacer ring 4X so as to be positioned. The other elements other than the first lens 5X and the second lens 9 among the elements are fitted into the lens barrel 1X so as to be positioned.

After all the elements housed in the lens barrel 1X are positioned, the pressing member 6X presses all the elements so as to be secured to the lens barrel 1X.

### Deformation of Lens During Assembly of Lens Unit 100X

When a pressing force is applied to a lens during the assembly of the lens unit 100X, the lens is deformed. More specifically, the lens is compressed by being pressed in the direction along the optical axis CX. If the distortion caused by such compression is not balanced with the moment applied to the lens, the lens may be bent.

The distortion of the lens is determined by the geometrical moment of inertia according to the shape of the lens and the moment applied to the lens. Since the geometrical moment of inertia depends on the thickness of the lens, the thinner the lens is, the larger the deformation of the lens due to its bending becomes. The bending of the lens hampers the flange portion from completely absorbing the deformation of the lens and thus deforms the lens portion.

It is also conceivable to reduce the lens distortion by adjusting the position to which the pressing force is applied, for each of the lenses and the lens barrel 1X, to cancel the moments. However, the moments might not be successfully canceled out, which causes the deformation of the lens, because of the manufacturing errors of the lenses and lens barrel 1X.

For example, when the flatness errors of the lens or the 1X of the lens barrel are large as the manufacturing errors, the position in the radial direction to which the pressing force is applied changes, and the deformation direction and the deformation amount of the lens change.

In addition to the manufacturing error, a change in the amount of distortion caused by the pressing force is also a factor that hampers an appropriate cancellation of the moments. Although the torque manages the pressing force, the pressing force fluctuates due to variations in the tightening torque, and errors in the relation between the pressing force and the torque. The amount of distortion is proportional to the pressing force, which means that as the pressing force varies more, the variation in the amount of distortion increases.

When the lens unit 100X is attached to an image-capturing device having an imaging element, the performance change of the lens unit 100X may be corrected by adjusting the relative position between the imaging element and the lens unit 100X. However, when the lens is deformed by any of the factors mentioned above, the lens cannot be appropriately corrected, and the performance of the lens unit 100X is changed.

### Deformation of Lens Due to Environmental Temperature Change

When the ambient temperature around the lens unit 100X changes, each element in the lens unit 1X including the lens unit 100X expands or contracts according to its linear thermal expansion coefficient.

The pressing force applied to each element changes with a difference in the amount of expansion or contraction between the elements.

The amount of distortion of the lens is proportional to the pressing force. This means that, with variations in the deformed state of the lens at the time of assembling the lens unit 100X, the amount of distortion of the lens changes with the ambient temperature around the lens unit 100X. In the state of the lens at the time of the assembly, its deformation increases with an increasing amount of distortion for the lens unit 100X. Further, with a reduced amount of distortion for the lens unit 100X, the amount of its deformation decreases. As a result, the variations in the amount of distortion between multiple lens units 100X increase according to the variations in the amount of deformation at the time of assembly.

In addition, any difference in expansion between the lens and an element in contact with the lens causes a shearing force due to a frictional force in a radial direction. The local occurrence of such a shearing force causes an imbalance of moments, causing the lens distortion. For this reason, irrespective of a small amount of deformation at the time of assembling the lens unit 100X, a significant amount of deformation of the lens might occur with the ambient temperature changes, which affects the performance of the lens unit 100X.

### Temporal Change in Lens Deformation

Since the resin lens has viscoelasticity, it is preferable to consider the influence of stress relaxation and creep deformation. Stress relaxation refers to a phenomenon in which stress is relaxed with the lapse of time with the stress being applied. The stress relaxation reduces the pressing force applied to the lens unit 100X. Since the amount of distortion of the lens is substantially proportional to the pressing force, the deformation of the resin lens may change with time depending on the deformed state of the resin lens at the time of assembling the lens unit 100X.

Creep deformation is a phenomenon that changes deformation with a constant force applied. Since the distribution of stresses inside the resin lens varies depending on the shape of the resin lens at the time of assembling the lens unit 100X, the amount of deformation of the resin lens may change with time because of creep deformation.

In addition to the above-described deformation, the axial misalignment of a lens might increase in a lens unit including a resin lens. In a lens unit including a resin lens, the difference in linear expansion coefficient between the lens barrel and the resin lens is greater than that between the glass lens and the lens barrel. To prevent the resin lens from being press-fit into the lens barrel, which is caused by the expansion of the resin lens in the radial direction when the environmental temperature around the lens unit changes, a clearance in the radial direction is preferably increased. For this reason, axial misalignment of the lens with respect to the lens barrel may occur by an amount corresponding to the clearance during assembly. In addition, an element housed in the lens barrel may move within the clearance with a change in the ambient temperature around the lens unit or a change over time in the lens unit. This movement might cause an increase in the axial misalignment of the lens in the radial direction from the axial misalignment at the time of assembly.

### Advantageous Effects of Lens Unit 100 of First Embodiment

The lens unit 100 according to the present embodiment includes a resin lens 2, a glass lens 5 (multiple lenses), a fit-receiving portion B, a lens barrel 1, and a pressing member 6 (a pressure member). The lens barrel 1 houses the resin lens 2 and the glass lens 5. The pressing member 6 presses the resin lens 2 and the glass lens 5 housed in the lens barrel 1. The resin lens 2 includes a fit-in portion A to be fitted into the fit-receiving portion B. Each of the fit-in portion A and the fit-receiving portion B has a tapered shape with different diameters of a circle around the optical axis C along the optical axis C. In other words, Each of the fit-in portion A and the fit-receiving portion B has a tapered cross-sectional shape in the optical axis; a shape of a circle centered on the optical axis C in a plane orthogonal to the optical axis C; and a diameter of the circle differs with a position in the optical within each of the fit-in portion A and the fit-receiving portion B.

The resin lens 2 housed in the lens barrel 1 and positioned by the fit-in portion A fitted into the fit-receiving portion B is deformed by being pressed by the pressing member 6 at the time of the assembly of the lens unit 100. The deformation of the resin lens 2 fills the gap between the fit-in portion A and the fit-receiving portion B, causing the fit-in portion A and the fit-receiving portion B to come into contact with each other. This reduces or prevents further deformation of the resin lens 2, thus reducing the performance change of the lens unit 100 due to the deformation of the resin lens 2. That configuration also restricts an increase in the amount of distortion of the resin lens 2 irrespective of a change in the pressing force applied by the pressing member 6, and thus reduces the performance change of the lens unit 100 due to a change in pressing force.

At the time of the assembly of the lens unit 100, moments are well balanced irrespective of a change in pressing force due to temperature changes. This allows a lower sensitivity of deformation to the pressing force. Thus, variations in the amount of change of a resin lens between multiple lens units 100 are reduced.

With a change in ambient temperature around the lens unit 100, an expansion difference between the elements of the lens unit 100 might cause a frictional force at a contact portion between the elements. Irrespective of such a case, the drag force N and the moments are held in balance so that a change in the shape of the resin lens 2 is reduced. As a result, the amount of deformation of the resin lens 2, which was predicted by the structural analysis at the time of designing the lens unit 100, is utilized in the lens design, and the design in consideration of the amount of deformation of the resin lens 2 becomes possible.

The lens unit 100 has a low sensitivity of deformation of the resin lens 2 to a change in pressing force. This configuration allows a more minor change in the amount of deformation of the resin lens 2 irrespective of a change in pressing force or creep deformation due to stress relaxation with time passed after the assembly of the lens unit 100. For the creep deformation, since the variations in the shape change of the resin lens 2 at the time of assembly is small between multiple lens units 100, the variations in the amount of deformation of the resin lens 2 due to creep deformation are reduced.

In the lens unit 100, the fit-receiving portion B of the lens barrel 1 and the fit-in portion A of the resin lens 2 are brought into contact with each other at the time of assembly, and a force is applied to the contact portion in the radial direction. This restricts the movement of the resin lens 2 in the radial direction. With the fit-receiving portion B and the fit-in portion A kept in contact with each other, the amount of movement of the first resin lens in the radial direction is reduced irrespective of temperature changes or changes with time. This configuration allows the lens unit 100 with reduced axial misalignment and decentering of the resin lens 2.

Embodiments of the present disclosure enable a lens unit that reduces or prevents a change in its state from that at the time of assembly.

The multiple lenses are not limited to two lenses and may be three or more lenses. The number of resin lenses is not limited to one and may be two or more. The tapered shape of each of the fit-in portion A and the fit-receiving portion B is not limited to the shape in which the diameter increases in the −Z-direction and may be a shape in which the diameter increases in the +Z-direction.

In the present embodiment, the resin lens 2 includes a lens portion 21 and a flange portion 22 formed outside the lens portion 21. The flange portion 22 includes a fit-in portion A. This configuration allows active deformation of the flange portion 22 in response to the deformation of the resin lens 2 and thus reduces or prevents the deformation of the lens portion 21. The configuration of the present embodiment provides a lens unit 100 that enables a reduction in its performance changes. However, the present disclosure is not limited to such a configuration.

In the present embodiment, the resin lens 2 includes a ring-shaped first portion 221 that comes into contact with the lens barrel 1 (first member) and a ring-shaped second portion 222 that comes into contact with the spacer ring 4 (second member) and opposite to the first portion 221 in the direction along the optical axis C. In the resin lens 2, the second portion 222 is between the fit-in portion A and the first portion 221 in a direction orthogonal to the optical axis C. This configuration allows the drag force N and the pressing force F to be applied to the resin lens 2 at different positions in the radial direction and thus reduces the moment applied to the resin lens 2.

### Second Embodiment

The configuration of the lens unit according to the second embodiment will be described with reference to FIGS. 1 and 2. The same components as those in the first embodiment are denoted by the same reference numerals, and redundant description thereof will be omitted as appropriate. This applies to other embodiments described below.

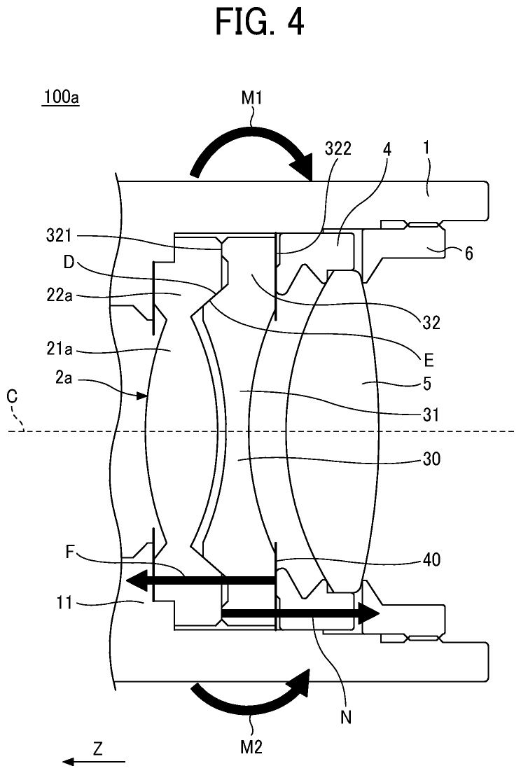

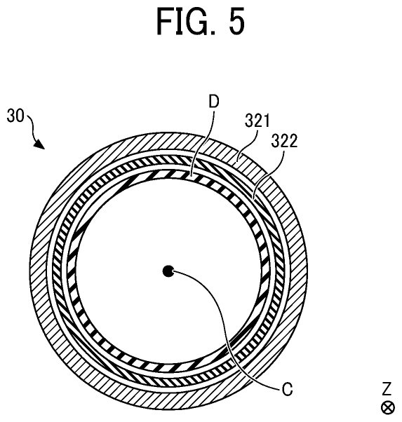

FIG. 4 is a vertical cross-sectional view of the configuration of the lens unit 100a according to the second embodiment. FIG. 5 is a plan view of a second resin lens 30 included in the lens unit 100a in FIG. 4 in a direction orthogonal to the −Z-direction.

As illustrated in FIG. 4, the lens unit 100a includes the second resin lens 30 and the light shield 40. The first resin lens 2a, the second resin lens 30, and the glass lens 5 correspond to multiple lenses arranged along the optical axis C. The first resin lens 2a and the second resin lens 30 are two resin lenses disposed adjacent to each other.

At least a part of the outer periphery of the resin lens 2a is formed in a substantially circular columnar shape. The outer diameter of the substantially circular columnar shape of the first resin lens 2a is smaller than the inner diameter of the lens barrel 1. Thus, the first resin lens 2a is housed in the lens barrel 1 with a gap between the first resin lens 2a and the lens barrel 1.

The first resin lens 2a includes a lens portion 21a and a flange portion 22a. The lens portion 21a has the optical axis C at its center and acts as a lens for the light incident on the first resin lens 2a.

The flange portion 22a is outside the lens portion 21a. The flange portion 22a does not act as a lens for the light incident on the first resin lens 2a. The flange portion 22a includes a fit-receiving portion E.

The fit-receiving portion E includes a tapered shape in which a diameter with the optical axis C as its center varies depending on a position in a direction along the optical axis C. In the present embodiment, the fit-receiving portion E includes a substantially conical tapered shape in which the diameter of a circle centered on the optical axis C increases in the −Z-direction.

At least a part of the outer periphery of the second resin lens 30 is formed in a substantially circular columnar shape. The outer diameter of the substantially circular columnar shape of the second resin lens 30 is smaller than the inner diameter of the lens barrel 1. Thus, the second resin lens 30 is housed in the lens barrel 1 with a gap between the second resin lens 30 and the lens barrel 1.

The second resin lens 30 includes a lens portion 31 and a flange portion 32. The lens portion 31 has the optical axis C at its center and acts as a lens for the light incident on the second resin lens 30.

The flange portion 32 is outside the lens portion 31. The flange portion 32 does not act as a lens for the light incident on the second resin lens 30. The flange portion 32 includes a fitting portion D, a first portion 321, and a second portion 322.

The fit-in portion D can be fitted to the fit-receiving portion E. The diameter of the tapered shape in the fit-in portion D is slightly smaller than the diameter of the tapered shape in the fit-receiving portion E as a whole. The fit-in portion D is formed at the +Z-side surface of the flange portion 32. The fit-in portion D includes a tapered shape in which a diameter with the optical axis C as its center varies depending on a position in the direction along the optical axis C. In the present embodiment, the fit-in portion D includes a substantially conical tapered shape in which the diameter of a circle centered on the optical axis C increases in the −Z-direction.

The first portion 321 is ring-shaped, contacting the first resin lens 2a. The first resin lens 2a is an example of a first member. The first portion 321 is a side surface of the flange portion 32, the side surface facing in the +Z-direction and being substantially orthogonal to the optical axis C. The first portion 321 comes into contact with an annular region of a face of the first resin lens 2a, the face being substantially orthogonal to the optical axis C.

The second portion 322 is a ring-shaped portion that comes into contact with the spacer ring 4 at the opposite side of the flange portion 32 across the first portion 321 along the optical axis C. The second portion 322 is another side surface of the flange portion 32, said another side surface facing in the-Z-direction and being substantially orthogonal to the optical axis C. The spacer ring 4 has a face substantially orthogonal to the optical axis C, which comes into contact with the ring-shaped region of the second portion 322 with the light shield 40 between the face of the spacer ring 4 and the second portion 322.

As illustrated in FIG. 5, in the second resin lens 30, the second portion 322 is between the fit-in position D and the first portion 321 in a direction orthogonal to the optical axis C. In other words, the relative position between the fit-in portion D, the first portion 321, and the second portion 322 are such that the fit-in portion D, the second portion 322, and the first portion 321 are arranged in order of distance from the optical axis C.

As illustrated in FIG. 4, the light shield 40 blocks disturbance light and unintended reflected light striking the lens unit 100a. For example, the light shield 40 is a sheet member with a thickness of about several tens of μm. The material of the light shield 40 is not limited to any particular material but may use a resin or a metal. Note that the light shield 40 may not be used.

In the lens unit 100 according to the first embodiment described above, the fit-receiving portion B made of metal and the fit-in portion A made of resin are fitted together. By contrast, in the present embodiment, both the fit-receiving portion E and the fit-in position D are made of resin. In this configuration, the expansion difference between the fit-in position D and the fit-receiving portion E becomes small when the ambient temperature around the lens unit 100a changes. This allows a small pressing force for maintaining the fit-in portion D and the fit-receiving portion E in contact with each other. In addition, since the shearing force caused by the expansion difference at the contact portion between the fit-in portion D and the fit-receiving portion E is also small, it is possible to reduce the amount of deformation of each of the first resin lens 2a and the second resin lens 30 due to the change in the ambient temperature.

Effects other than those described above are the same as those of the first embodiment.

### Third Embodiment

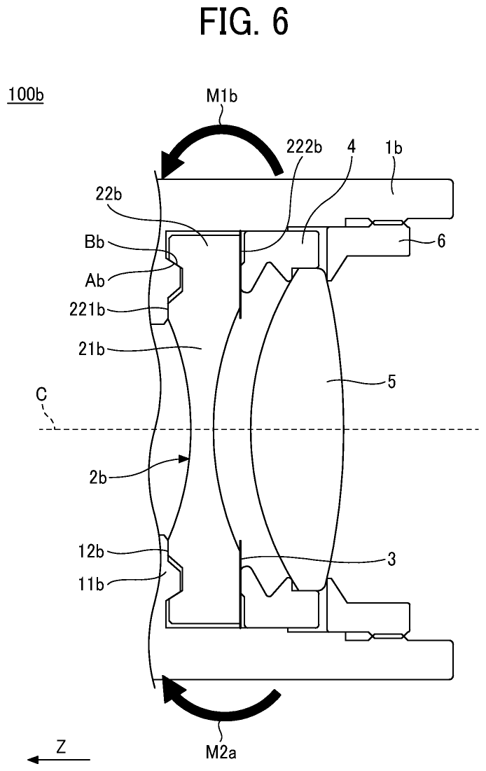

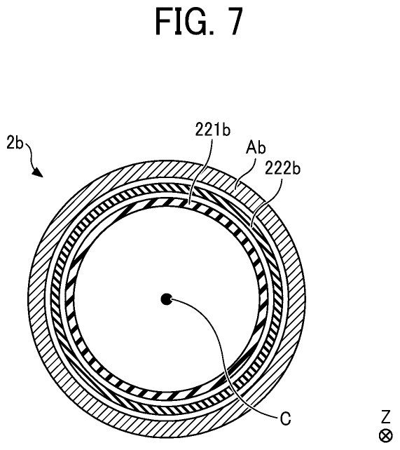

The configuration of the lens unit according to the third embodiment will be described with reference to FIGS. 6 and 7. FIG. 6 is a vertical cross-sectional view of the configuration of a lens unit 100b according to the third embodiment. FIG. 7 is a plan view of the resin lens 2b in the lens unit 100b of FIG. 6 in a direction orthogonal to the −Z-direction.

As illustrated in FIG. 6, the lens unit 100b includes a lens barrel 1b and a resin lens 2b.

The lens barrel 1b includes a fit-receiving portion Bb and houses the resin lens 2b and the glass lens 5.

The material of the lens barrel 1b is metal such as aluminum. However, the material of the lens barrel 1b may be resin.

In the present embodiment, the lens barrel 1b is formed in a hollow substantially-circular tubular shape and includes the resin lens 2b, the light shield 3, the spacer ring 4, and the glass lens 5 internally housed in that order. The lens barrel 1b includes a small-diameter portion 11b and a contact surface 12b.

The small-diameter portion 1b1 is ring-shaped provided in a part of the inner side of the lens barrel 1. The inner diameter of the small-diameter portion 11b is smaller than any of the outer diameters of the resin lens 2b and the glass lens 5 housed in the lens barrel 1. The small-diameter portion 11b includes a fit-receiving portion Bb.

The fit-receiving portion Bb includes a tapered shape in which a diameter with the optical axis C as its center varies depending on a position in a direction along the optical axis C. In the present embodiment, the fit-receiving portion Bb includes a substantially conical tapered shape in which the diameter of a circle centered on the optical axis C increases in the +Z-direction.

The contact surface 12b included in the small-diameter portion 11b is a surface substantially orthogonal to the optical axis C of the lens unit 100b. The resin lens 2b housed in the lens barrel 1b is brought into contact with the contact surface 12b.

At least a part of the outer periphery of the resin lens 2b is formed in a substantially circular columnar shape. The outer diameter of the substantially circular columnar shape of the resin lens 2b is smaller than the inner diameter of the lens barrel 1b. Thus, the first resin lens 2b is housed in the lens barrel 1b with a gap between the resin lens 2b and the lens barrel 1b.

The first resin lens 2b includes a lens portion 21b and a flange portion 22b. The lens portion 21b has the optical axis C at its center and acts as a lens for the light incident on the first resin lens 2b.

The flange portion 22b is outside the lens portion 21b. The flange portion 22b does not act as a lens for the light incident on the resin lens 2b. The flange portion 22b includes a fitting portion Ab, a first portion 221b, and a second portion 222b.

The fit-in portion Ab can be fitted to the fit-receiving portion Bb. The diameter of the tapered shape in the fit-in portion Ab is slightly smaller than the diameter of the tapered shape in the fit-receiving portion Bb as a whole. The fit-in portion Ab is formed at the +Z-side surface of the flange portion 32b. The fit-in portion Ab includes a tapered shape in which a diameter with the optical axis C as its center varies depending on a position in the direction along the optical axis C. In the present embodiment, the fit-in portion Ab includes a substantially conical tapered shape in which the diameter of a circle centered on the optical axis C increases in the +Z-direction.

The first portion 221b is ring-shaped, contacting the lens barrel 1b. The lens barrel 1b is an example of a first member. The first portion 221b is another side surface of the flange portion 22b, said another side surface facing in the −Z-direction and being substantially orthogonal to the optical axis C. The first portion 221b comes into contact with an annular region of a face of the small-diameter portion 11 of the lens barrel 1b, the face being substantially orthogonal to the optical axis C.

The second portion 222b is a ring-shaped portion that comes into contact with the spacer ring 4 at the opposite side of the flange portion 22b across the first portion 221b along the optical axis C. The second portion 222b is another side surface of the flange portion 22b, said another side surface facing in the-Z-direction and being substantially orthogonal to the optical axis C. The spacer ring 4 has a face substantially orthogonal to the optical axis C, which comes into contact with the ring-shaped region of the second portion 222b with the light shield 3 between the face of the spacer ring 4 and the second portion 222b.

As illustrated in FIG. 7, in the resin lens 2b, the second portion 222b is between the fit-in position Ab and the first portion 221 in a direction orthogonal to the optical axis C. In other words, the relative position between the fit-in portion Ab, the first portion 221b, and the second portion 222b is such that the fit-in portion Ab, the first portion 221b, and the second portion 222b are arranged in order of distance from the optical axis C.

Moment M1b and moment M2a represent moments applied to the resin lens 2b. The moment M1b is opposite to the moment M1 in FIG. 1, i.e., directed in the +Z-direction. The moment M2a is opposite to the moment M2 in FIG. 1, i.e., directed in the +Z-direction.

The lens unit 100b exhibits advantageous effects similar to those of the lens unit 100 according to the first embodiment.

The followings are aspects of the present disclosure to achieve the intended performance.

### Aspect 1

A lens unit includes: multiple lenses arranged along an optical axis of the lens unit, the multiple lenses including at least one resin lens; a lens barrel housing the multiple lenses, the lens barrel including a fit-receiving portion; and a pressure member configured to press the multiple lenses housed in the lens barrel. Said at least one resin lens including a fit-in portion fittable into the fit-receiving portion. Each of the fit-in portion and the fit-receiving portion has: a tapered cross-sectional shape in the optical axis; and a shape of a circle centered on the optical axis in a plane orthogonal to the optical axis. A diameter of the circle differs with a position in the optical axis.

### Aspect 2

In the lens unit according to Aspect 1, said at least one resin lens further includes: a lens portion; and a flange portion outside the lens portion in a radial direction from the optical axis in the plane. The flange portion includes the fit-in portion.

### Aspect 3

In the lens unit according to Aspect 1 or 2, the lens barrel includes a first member, the lens unit further includes a second member housed in the first member. Said at least one resin lens further includes: a first portion having a ring shape, the first portion at one end of said at least one resin lens in the optical axis and contacting the first member; and a second portion having a ring shape, the second portion at another end of said at least one resin lens in the optical axis and contacting the second member. The second portion is between the fit-in portion and the first portion in the radial direction.

### Aspect 4

In the lens unit according to Aspect 1, the fit-receiving portion has a conical shape, the diameter of which increasing toward the pressure member in the optical axis.

### Aspect 5

A lens unit includes: multiple lenses arranged along an optical axis of the lens unit, the multiple lenses including at least two resin lenses; a lens barrel housing the multiple lenses; and a pressure member configured to press the multiple lenses housed in the lens barrel. Said at least two resin lenses includes: a first resin lens; and a second resin lens adjacent to the first resin lens. The first resin lens includes a fit-receiving portion. The second resin lens includes a fit-in portion fittable into the fit-in portion. Each of the fit-in portion and the fit-receiving portion has: a tapered cross-sectional shape in the optical axis; and a shape of a circle centered on the optical axis in a plane orthogonal to the optical axis. A diameter of the circle differs with a position in the optical axis.

### Aspect 6

In the lens unit according to Aspect 5, the first resin lens includes: a first lens portion; and a first flange portion outside the first lens portion in a radial direction from the optical axis in the plane. The first flange includes the fit-receiving portion. The second resin lens further includes: a second lens portion; and a second flange portion outside the second lens portion in the radial direction, the second flange portion including the fit-in portion.

### Aspect 7

In the lens unit according to Aspect 5 or 6, the first resin lens is a first member. The lens unit further includes a second member housed in the lens barrel. The second resin lens further includes: a first portion having a ring shape at one end of the second resin lens along the optical axis and contacting the first member; and a second portion having a ring shape at another end opposite to the first portion along the optical axis and contacting the second member. The second portion is between the fit-in portion and the first portion in a direction orthogonal to the optical axis.

### Aspect 8

In Aspect 8, the lens unit according to Aspect 5, the fit-receiving portion has a conical shape, the diameter of which increasing toward the pressure member in the optical axis.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2022-080957, filed on May 17, 2022, in the Japan Patent Office, the entire disclosure of which is hereby incorporated by reference herein.

### REFERENCE SIGNS LIST

1, 1b lens barrel
11, 11b small-diameter portion
12, 12b contact surface
2, 2b resin lens
2a first resin lens
21, 21a, 21b lens portion
22, 22a, 22b flange portion
221, 221b first portion
222, 222b second portion
3, 40 light shield
4 spacer ring
5 glass lens
6 pressing member
30 second resin lens
31 lens portion
32 flange portion
321 first portion
322 second portion
100, 100a, 100b lens unit
A, Ab, D fit-in portion
B, Bb, E fit-receiving portion
C optical axis
F pressing force
M1, M2, M1b, M2b moment
N drag force

1. A lens unit comprising:
multiple lenses arranged along an optical axis of the lens unit, the multiple lenses including at least one resin lens;
a lens barrel housing the multiple lenses, the lens barrel including a fit-receiving portion; and
a structure which presses the multiple lenses housed in the lens barrel,
wherein:
said at least one resin lens including a fit-in portion fittable into the fit-receiving portion,
each of the fit-in portion and the fit-receiving portion includes:
a tapered cross-sectional shape [[in]] on the optical axis; and
a shape of a circle centered on the optical axis in a plane orthogonal to the optical axis, and
a diameter of the circle differs with a position on the optical axis.

2. The lens unit according to claim 1, wherein:
said at least one resin lens further includes:
a lens portion; and
a flange portion outside the lens portion in a radial direction from the optical axis in the plane, and
the flange portion includes the fit-in portion.

3. The lens unit according to claim 1, wherein:
the lens barrel includes a first member,
the lens unit further comprises a second member housed in the first member,
said at least one resin lens further includes:
a first portion having a ring shape, the first portion at one end of said at least one resin lens on the optical axis and contacting the first member; and
a second portion having a ring shape, the second portion at another end of said at least one resin lens on the optical axis and contacting the second member, and
the second portion is between the fit-in portion and the first portion in a radial direction from the optical axis.

4. The lens unit according to claim 1, wherein;
the fit-receiving portion has a conical shape, the diameter of which increasing toward the structure which presses along the optical axis.

5. A lens unit comprising:
multiple lenses arranged along an optical axis of the lens unit, the multiple lenses including at least two resin lenses;
a lens barrel housing the multiple lenses; and
a structure which presses the multiple lenses housed in the lens barrel,
wherein:
said at least two resin lenses include:
a first resin lens; and
a second resin lens adjacent to the first resin lens,
the first resin lens includes a fit-receiving portion,
the second resin lens includes a fit-in portion fittable into the fit-in portion, and
each of the fit-in portion and the fit-receiving portion includes:
a tapered cross-sectional shape on the optical axis; and
a shape of a circle centered on the optical axis in a plane orthogonal to the optical axis,
a diameter of the circle differs with a position on the optical axis.

6. The lens unit according to claim 5, wherein:
the first resin lens includes:
a first lens portion; and
a first flange portion outside the first lens portion in a radial direction from the optical axis in the plane, the first flange including the fit-receiving portion, and
the second resin lens further includes:
a second lens portion; and
a second flange portion outside the second lens portion in the radial direction, the second flange portion including the fit-in portion.

7. The lens unit according to claim 5, wherein;
the first resin lens is a first member,
the lens unit further comprises a second member housed in the lens barrel,
the second resin lens further includes:
a first portion having a ring shape at one end of the second resin lens along the optical axis and contacting the first member; and
a second portion having a ring shape at another end opposite to the first portion along the optical axis and contacting the second member, and
the second portion is between the fit-in portion and the first portion in a direction orthogonal to the optical axis.

8. The lens unit according to claim 5, wherein:
the fit-receiving portion includes a conical shape, the diameter of which increasing toward the structure which presses along the optical axis.
